(19) United States
(12) Patent Application Publication
(10) Pub. No.: US 2025/0160327 A1
(43) Pub. Date: May 22, 2025

(54) USE OF CHROMENE OR CHROMANE DERIVATIVES AS HERBICIDAL AGENTS

(71) Applicants: ECOLE POLYTECHNIQUE, Palaiseau cedex (FR); CENTRE NATIONAL DE LA RECHERCHE SCIENTIFIQUE, PARIS (FR); SORBONNE UNIVERSITE, Paris (FR); ECOLE NATIONALE SUPERIEURE DE TECHNIQUES AVANCEES, Palaiseau Cedex (FR)

(72) Inventors: Bastien NAY, Paris (FR); Emmanuel Alain, Simon BAUDOUIN, Thiais (FR); Bruce WALTERS, Orsay (FR); Simon Michel THUILLIER, Paris (FR)

(73) Assignees: ECOLE POLYTECHNIQUE, Palaiseau Cedex (FR); CENTRE NATIONAL DE LA RECHERCHE SCIENTIFIQUE, PARIS (FR); SORBONNE UNIVERSITE, Paris (FR); ECOLE NATIONALE SUPERIEURE DE TECHNIQUES AVANCEES, Palaiseau Cedex (FR)

(21) Appl. No.: 18/839,167

(22) PCT Filed: Feb. 15, 2023
(86) PCT No.: PCT/EP2023/053769

§ 371 Date: Aug. 16, 2024

(30) Foreign Application Priority Data
Feb. 17, 2022 (FR) 2201378

(51) Int. Cl. A01N 43/16; A01P 13/00

(52) U.S. Cl. CPC A01N 43/16; A01P 13/00

(57) ABSTRACT

Herbicides useful for controlling the proliferation of undesired plants. In particular, the use of at least one compound derived from chromene or chromane as a herbicidal agent, a phytotoxic composition including the at least one compound derived from chromene or chromane, as well as a method for treating and/or controlling plants using the at least one compound derived from chromene or chromane.

### FIELD

The present invention applies to the field of herbicides useful for combatting the proliferation of undesirable plants. In particular, the invention relates to the use of at least one chromene or chromane derivative compound as herbicidal agent, to a phytotoxic composition comprising said compound, thus as to a plant treatment and/or control method implementing such a compound.

### BACKGROUND

Weeds are considered to be one of the scourges which cause the most losses in agricultural production worldwide, and which are responsible for more than 30% of the drop in yields and crop quality. They appear throughout the crop growth period and are particularly damaging at sowing time and during harvest. Over the last 60 years, weeds have been controlled almost exclusively by the application of herbicides of non-natural origin, against which these weeds have developed increasing resistance. For example, more than 50 species of “weeds” with proven resistance to glyphosate, a broad-spectrum systemic herbicide widely used for agricultural and non-agricultural purposes, are currently confirmed according to the international “Herbicide-Resistant Weed Database” as “superweeds”.

Research teams are therefore looking for sustainable solutions and alternatives, especially based on natural substances.

Among the new synthetic molecules based on natural substances, mention may be made of triketones (mesotrione, topramezone, tembotrione) based on leptospermone isolated from the plant Callistemon or lemon bottlebrush, which would inhibit the enzyme p-hydroxyphenylpyruvate dioxygenase; cinmethyline based on isocineole, a terpene found in cardamom or some varieties of pepper, which would inhibit tyrosine aminotransferase; and endothall based on cantharidin, a powerful defence toxin produced by insects, which would inhibits protein phosphatases in plants. In particular, leptospermone was discovered in the late 1970s after it was noticed that lemon bottlebrush inhibited growth of other plants in their environment, indicating the presence of a substance with allelopathic properties.

The literature has also provided natural substances such as glufosinate, also known as phosphinothricin and often sold as an ammonium salt, derived from the degradation of bialaphos (or bilanaphos), a tripeptide isolated from bacteria. However, it was withdrawn from the market in 2017 due to its classification as a possible reprotoxic chemical. Other natural substances such as fatty acids have been marketed as biopesticides (e.g. pelargonic acid marketed under the reference Beloukha® agent or acetic acid) acting as superficial defoliants. Their activity is therefore limited in time.

Other research teams have focused on synthetic chromene- or chromane-based molecules. In particular, U.S. Pat. No. 5,053,071 describes broad-spectrum herbicides comprising a chromane unit having one of the following formulae:

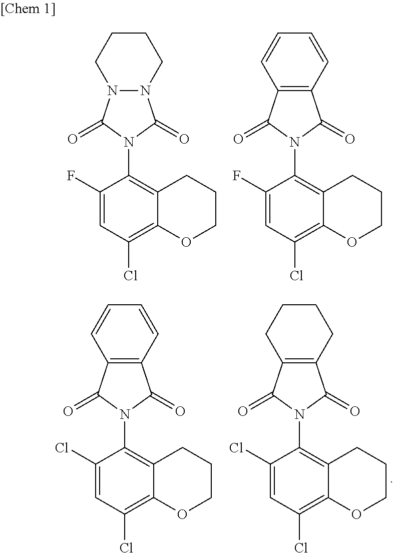

Some compounds of U.S. Pat. No. 5,053,071 comprise stereoisomers, which may pose problems in terms of synthesis strategy, purification, and characterisation of biological activity. In addition, the synthetic route starting from a phenolic ring involves numerous steps using conditions that are difficult to implement on a large scale (allylation of a complex phenol, high temperature Claisen rearrangement, hydroboration, cyclisation, and then functionalisation).

International application WO2019/005484 describes herbicides comprising a chromene unit having the following formula:

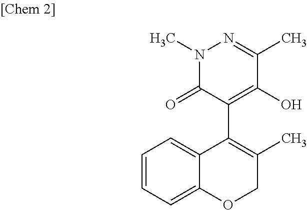 [SMILES: CC1=C(c2c(O)c(C)nn(C)c2=O)c2ccccc2OC1]

However, some of the compounds in WO2019/005484 have asymmetric centres, leading to enantiomers, diastereoisomers and/or atropoisomers, which may pose problems in terms of synthesis strategy, purification and, above all, characterisation of biological activity. As for their synthesis routes, they are not precisely described.

There is therefore a need for new herbicidal agents which are effective against undesirable plants, easy to prepare, and whose side effects on the environment are significantly reduced compared with those aforementioned.

### SUMMARY

Thus, the aim of the present invention is to overcome the drawbacks of the aforementioned prior art and to provide a herbicidal agent with good performance in terms of herbicidal activity and/or selectivity, which is easy to prepare and has reduced toxicity.

The aim of the invention is achieved by the chromene and chromane derivative compounds described hereinafter.

The first object of the present invention is thus the use of at least one compound selected from a compound corresponding to formula (I), one of its isomers, one of their organic and inorganic salts, as a herbicidal agent,
said formula (I) having the following structure:

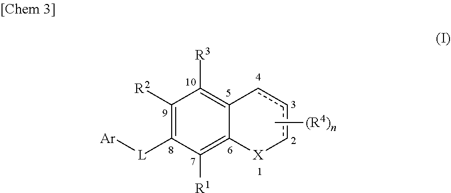

wherein:
   R¹, R² and R³ represent, independently of each other, a hydrogen atom, a halogen atom, a C₁-C₅ alkyl or cycloalkyl radical, or a group selected from —OH, —COOH, —COOR⁵, —OR⁵ and —SO₂R⁵, with R⁵ being a C₁-C₅ alkyl or cycloalkyl radical, it being possible for said C₁-C₅ alkyl or cycloalkyl radical to be substituted with one or more substituents selected from a halogen atom and a hydroxyl group,
   X is part of a six-membered heterocycle and represents an oxygen atom, a sulphur atom, a divalent SO group, a divalent SO₂ group and a divalent NR⁶ group, with R⁶ being a hydrogen atom, a C₁-C₅ alkyl or cycloalkyl radical, or a C₂-C₈ aryl or heteroaryl radical,
   the symbol [symbol] represents a single bond or a double bond in the 2,3- or 3,4-position of the six-membered heterocycle bearing the heteroatom or the divalent group X, so that said six-membered heterocycle comprises either two single bonds in the 2,3- and 3,4-positions, or a single bond in the 2,3-position and a double bond in the 3,4-position, or a double bond in the 2,3-position and a single bond in the 3,4-position,
   L represents a bonding arm selected from linear and branched alkylene chains having at least one carbon atom, it being possible for said linear or branched alkylene chains to be interrupted and/or terminated by one or more heteroatoms selected from an oxygen, sulphur or substituted nitrogen atom,
   Ar represents an aromatic group selected from phenyl, naphthyl, furyl, thiophenyl, pyrrolyl, pyridinyl, indolyl, isoindolyl, benzofuryl, benzothiophenyl, quinolyl and isoquinolyl, imidazolyl, oxazolyl, thiazolyl, pyrimidyl, pyridazyl, pyrazyl, pyrrazolyl and triazolyl groups, it being possible for said aromatic group to be substituted with one or more substituents selected from a halogen atom, a C to C₅ alkyl or cycloalkyl radical, an —OH group, a —COOH group, a —COOR⁷ group, an —OR⁷ group, and an —SO₂R⁷ group, with R⁷ being a C₁ to C₈ alkyl or cycloalkyl radical, it being possible for said C₁ to C₅ alkyl or cycloalkyl radical to be substituted with one or more substituents selected from a halogen atom and a hydroxyl group,
   n is an integer ranging from 4 to 6 and represents the number of identical or different substituents R⁴ present on the six-membered heterocycle, and
   R⁴ represents a hydrogen atom, a halogen atom, a C₁ to C₅ alkyl or cycloalkyl radical, or a group selected from —OH, —COOH, —COOR⁸, —OR⁸ and —SO₂R⁸, with R⁸ being a C₁ to C₅ alkyl or cycloalkyl radical, it being possible for said C₁ to C₅ alkyl or cycloalkyl radical to be substituted with one or more substituents selected from a halogen atom and a hydroxyl group.

The compounds (I) of the invention are derivatives based on chromene (2H-chromene or 4H-chromene) or chromane (3,4-Dihydro-2H-1-benzopyran) including compounds existing naturally in Hepatica, plant mosses present especially in forests and wet zones, and compounds inspired by such compounds naturally existing in Hepatica. The inventors have thus discovered that such compounds according to the first object of the invention have significant herbicidal activity. Moreover, these compounds are easy to prepare and some can be directly extracted from the natural environment.

### DETAILED DESCRIPTION

For the purposes of the present invention, by “herbicidal agent”, it is intended a chemical product in the form of an active substance or a phytosanitary composition effective in combating the proliferation of undesirable plants.

A herbicidal agent can in particular be said to be total if it destroys all kinds of plants or selective if it kills only one or more categories of undesirable plants. It can also be described in terms of its mode of action, for example root penetration, systemic or post-emergence.

A “root-penetrating herbicidal agent” is a herbicidal agent which acts by being absorbed by the roots of the plant, whereas a “foliar herbicidal agent” is absorbed by the plant at the leaves.

A “systemic herbicidal agent” acts by spreading throughout the plant via the sap, as opposed to a “contact herbicidal agent” which only destroys surfaces to which it is applied and is therefore in contact.

Finally, a “post-emergence herbicidal agent” acts on the plant after the first seedlings have emerged, whereas a “pre-emergence herbicidal agent” makes it possible to act as soon as they germinate.

In the present invention, “isomers” are understood to mean steric and optical structural isomers, said isomers having the same molar mass as the compound of the formula (I), and the structural variations being limited to:
the position of X on the six-membered heterocycle,
the position of the tetrahedral carbon when the six-membered heterocycle comprises a double bond,
the position of the R¹, R², R³ and L-Ar groups on the phenyl group, and
the position of the n groups R⁴ on the six-membered heterocycle.

By way of example of inorganic salts of the compound of the formula (I) and its isomers, mention may be made of the alkali metal and alkaline earth metal salts of the compound of the formula (I) and its isomers.

By way of example of organic salts of the compound of the formula (I) and its isomers, mention may be made of ammonium salts of the compound of the formula (I) and its isomers.

In the present invention, C₁ to C₈ alkyl or cycloalkyl radical may be linear or branched, and is preferably linear.

For the purposes of the present invention, a halogen is selected from F, Cl, Br and I, and particularly preferably from F and Cl.

### Definition of X

The alkyl or cycloalkyl radical as group R⁶ is preferably an alkyl radical, particularly preferably a linear alkyl radical, and more particularly preferably a linear C₁ to C₃ alkyl radical.

The aryl radical as group R⁶ is preferably a C₅ to C₆ aryl radical, and particularly preferably a phenyl radical.

The heteroaryl radical as group R⁶ may be an indole or triazole radical. R⁶ as a C₂ to C₈ aryl or heteroaryl radical is preferably a C₅ to C₆ aryl radical.

The group R⁶ is preferably a hydrogen atom or an alkyl or cycloalkyl radical.

According to one particularly preferred embodiment of the invention, X represents an oxygen atom.

Definition of R¹, R², R³ and R⁵

The alkyl or cycloalkyl radical as group R¹, R² or R³ is preferably an alkyl radical, particularly preferably a linear alkyl radical, and more particularly preferably a linear C₁ to C₈ alkyl radical.

The alkyl or cycloalkyl radical as group R⁵ is preferably an alkyl radical, particularly preferably a linear alkyl radical, and more particularly preferably a linear C₁ to C₃ alkyl radical.

Said alkyl or cycloalkyl radical as group R¹, R², R³ or R⁵ may be substituted with one or more substituents selected from a halogen atom and a hydroxyl group.

According to one particularly preferred embodiment of the invention, at least one of the groups R¹, R² and R³ represents an —OH group, and advantageously the group R³ represents an —OH group. This makes it easier to obtain the compounds of the invention and to increase the herbicidal activity.

In this embodiment, the other two groups R¹ and R², or R¹ and R³, or R² and R³, and advantageously the other two groups R¹ and R², represent, independently of each other, a hydrogen atom, a —COOH group, or a —COOR⁵ group, with R⁵ being a C₁ to C₅ alkyl radical, and preferably a methyl radical.

Particularly preferably, still in this embodiment, the group R¹ represents a hydrogen atom or a —COOH group, and more particularly preferably a hydrogen atom.

Particularly preferably, still in this embodiment, the group R² represents a hydrogen atom, a COOH group or a COOR⁵ group, with R⁵ being a C₁ to C₅ alkyl radical, and preferably a methyl radical, and more particularly preferably a hydrogen atom or a —COOH group.

### The Six-Membered Heterocycle

Said six-membered heterocycle bearing the heteroatom or the divalent group X preferably comprises either two single bonds in the 2,3- and 3,4-positions, or a single bond in the 2,3-position and a double bond in the 3,4-position, and particularly preferably a single bond in the 2,3-position and a double bond in the 3,4-position.

### Definition of L

L preferably represents a linear or branched alkylene chain having from 1 to 6 carbon atoms, more particularly preferably a linear alkylene chain having from 2 to 3 carbon atoms, and more particularly preferably a linear alkylene chain having 2 carbon atoms.

The linear or branched alkylene chain as bonding arm L may be interrupted and/or terminated by one or more heteroatoms selected from an oxygen, sulphur and substituted nitrogen atom, and preferably by one or more oxygen atoms.

The nitrogen may be substituted with a C₁ to C₅, preferably C₁ to C₃, alkyl group, said alkyl radical being preferably a linear alkyl radical.

### Definition of Ar

The alkyl or cycloalkyl radical as substituent of the Ar group is preferably an alkyl radical, particularly preferably a linear alkyl radical, and more particularly preferably a linear C₁ to C₈ alkyl radical.

The alkyl or cycloalkyl radical as group R⁷ is preferably an alkyl radical, particularly preferably a linear alkyl radical, and more particularly preferably a linear C₁ to C₃ alkyl radical.

Said alkyl or cycloalkyl radical as substituent of the group Ar or group R⁷ may be substituted with one or more substituents selected from a halogen atom and a hydroxyl group.

Ar preferably represents a phenyl group, wherein said phenyl group can be substituted with one or more substituents as defined in the invention for the aromatic group Ar.

Among the substituents of the aromatic group Ar, the —OH group is preferred.

### Definition of n and R⁴

The six-membered heterocycle bearing the divalent group or heteroatom X comprises at least 4 substituents R⁴ and at most 6 substituents R⁴ depending on the presence or absence of a double bond within said heterocycle.

The alkyl or cycloalkyl radical as group R⁴ is preferably an alkyl radical, particularly preferably a linear alkyl radical, and more particularly preferably a C₁ to C₃ linear alkyl radical.

The alkyl or cycloalkyl radical as group R⁸ is preferably an alkyl radical, particularly preferably a linear alkyl radical, and more particularly preferably a linear C₁ to C₃ alkyl radical.

Said alkyl or cycloalkyl radical as group R⁴ or R⁸ may be substituted with one or more substituents selected from a halogen atom and a hydroxyl group.

According to a first alternative, the heterocycle comprises a double bond, the compound then having the following formula (Ia) or (Ib):

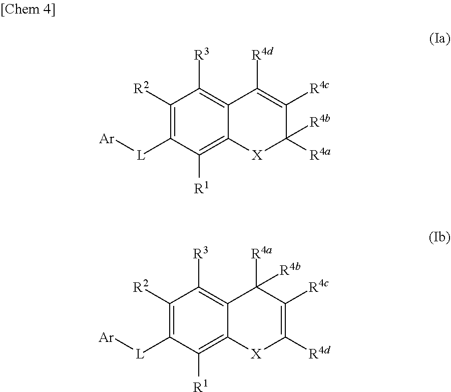

wherein:
   Ar, L, R¹, R², R³ and X are as defined in the invention, and
   R^{4a}, R^{4b}, R^{4c} and R^{4d}, which may be identical or different, represent a hydrogen atom or a C₁-C₅ alkyl or cycloalkyl radical, it being possible for said C₁-C₅ alkyl or cycloalkyl radical to be substituted with one or more halogen atoms.

According to a particularly preferred embodiment of this first alternative, R^{4a} represents a C₁-C₅ alkyl radical optionally substituted with one or more halogen atoms, R^{4b} represents a hydrogen atom or a C₁-C₅ alkyl radical optionally substituted with one or more halogen atoms, and R^{4c} and R^{4d} represent a hydrogen atom.

R^{4a} advantageously represents a C₁-C₃ alkyl radical optionally substituted with one or more halogen atoms, and even more advantageously a methyl radical. This thus makes it possible to improve the herbicidal efficacy.

When R^{4b} represents a C₁-C₅ alkyl radical optionally substituted with one or more halogen atoms, it is preferably a C₁-C₃ alkyl radical optionally substituted with one or more halogen atoms, and even more preferably a methyl radical.

According to a second alternative, the heterocycle does not comprise a double bond, the compound then having the following formula (Ic):

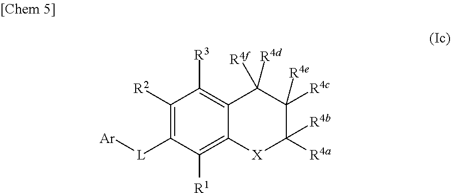

wherein:
   Ar, L, R¹, R², R³ and X are as defined in the invention, and
   R^{4a}, R^{4b}, R^{4c}, R^{4d}, R^{4e}, and R^{4f}, which may be identical or different, represent a hydrogen atom or a C₁-C₅ alkyl or cycloalkyl radical, it being possible for said C₁-C₅ alkyl or cycloalkyl radical to be substituted with one or more halogen atoms.

According to one particularly preferred embodiment of this second alternative, R^{4a} and R^{4b} represent a methyl radical, and R^{4c}, R^{4d}, R^{4e} and R^{4f} represent a hydrogen atom.

According to one preferred embodiment of the invention, the compound of the formula (I) is selected from the following compounds:

TABLE 1

| Name | Structural formula |
|---|---|
| Compound Ia1 | 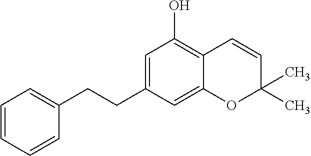 [SMILES: CC1(C)C=Cc2c(O)cc(CCc3ccccc3)cc2O1] |
| | [Chem 6] |
| Compound Ia2 | 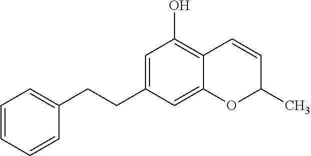 [SMILES: CC1C=Cc2c(O)cc(CCc3ccccc3)cc2O1] |
| | [Chem 7] |
| Compound Ia3 | 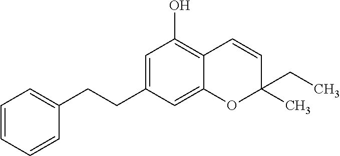 [SMILES: CCC1(C)C=Cc2c(O)cc(CCc3ccccc3)cc2O1] |
| | [Chem 8] |
| Compound Ic1 | 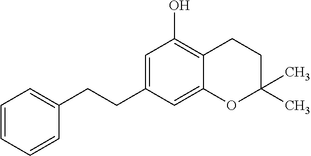 [SMILES: CC1(C)CCc2c(O)cc(CCc3ccccc3)cc2O1] |
| | [Chem 9] |

By virtue of their herbicidal biological activity, the compounds as defined in the first object of the invention are useful in the fields of agriculture, gardening and transport, especially for weeding tarmacs or railway tracks.

The compound as defined in the first object of the invention can be implemented in an isolated or non-isolated, and/or natural or synthetic form.

According to one embodiment, the compound as defined in the first object of the invention is implemented in isolated form.

According to the invention, the term “isolated form” intends the fact that the compound as defined in the first object of the invention is implemented in a pure form, i.e. distinct from a mixture with other compounds, which may be, for example, a plant extract containing it in combination with other substances.

Thus, these compounds as defined in the first object of the invention may be isolated from plant extracts but may also be prepared synthetically, especially as illustrated in the following examples.

According to another embodiment, the compound as defined in the first object of the invention is implemented in the form of a natural extract, especially of plant origin, containing it.

The natural origin makes it possible to contemplate a reduced environmental impact.

In particular, some compounds as defined in the first object of the invention may be implemented in the form of an extract of Hepatica plants containing them, especially and in a non-limiting manner: Radula laxiramea, Radula variabilis, Radula complanata, Radula buccinifera, Radula japonica, Radula oyamensis, Radula tokiensis, Radula perrottetii, Radula kojana, Radula javanica which may generally contain a mixture of these compounds as defined in the first object of the invention and other related compounds. The implementation may directly involve the plant, or any other biological agent enabling the compounds of the invention to be produced, dried and reduced to powder.

For example, compound (Ia1) was isolated from the plant Radula kojana [Asakawa et al., Phytochemistry, 1991, 30, 219-234].

The extract may especially be obtained by mechanical extraction, for example by pressing, or by chemical extraction, especially by leaching, maceration or infusion. If necessary, the extraction may be followed by a chromatography purification step or crystallisation.

According to yet another exemplary embodiment, the compound as defined in the first object of the invention may be generated in situ or just before use from a precursor, for example by hydrolysis, especially of an ester.

Of course, the different compounds as defined in the first object of the invention can be used in mixture as herbicidal active substances according to the invention.

According to the invention, a “herbicidal agent” corresponds to any compound or any composition having the property of killing so-called undesirable plants, especially plants.

These so-called “undesirable” plants are generally mosses, algae or weeds, and in a non-limiting manner especially, anthemis, amaranths, cocksfoot, mugwort, arrowroot, cornflower, shepherd's purse, bromes, cardamoms, thistles, goosefoot, creeping quackgrass, poppies, Stramonium datura, euphorbia, fumitory plants, bedstraw, galinsoga, geraniums, field ryegrass, sow thistle, lamb's-quarters, vetch, bindweed, chickweed, wild mustard, forget-me-nots, nettles, oxalis, pepperweed, field pansy, dandelion, plantain, radish, ryegrass, buttercup, knotweed, groundsel, corn spurry, speedwell and common vetch.

For example, so-called undesirable plants may be those listed in HYPPA (HYpermédia pour la Protection des Plantes-Adventices), an encyclopaedic database developed by INRAe Dijon, including data on 580 “weeds” of Western European crops.

As is apparent from the examples below, the compounds as defined in the first object of the invention are particularly highly advantageous as post-emergence herbicidal agents.

They are especially advantageous, on the one hand, as root-penetrating herbicidal agents and, on the other hand, as systemic herbicidal agents.

In particular, compounds as defined in the first object of the invention are used as herbicidal agents on plants at the development stage of the seedling, which is a young germinated plant including only a few leaves.

Compounds as defined in the first object of the invention are employed in a formulation suitable for application to the zone to be treated.

Generally speaking, this formulation dedicated to application is a liquid and generally aqueous formulation.

This liquid formulation may be supplied as such to the user, i.e. ready to use.

It may also be a concentrated liquid formulation which has to be diluted by the user just before use.

It may also be a formulation in solid form, such as granules for example, to be applied as such by the user or to be dispersed in an aqueous medium before use.

Generally speaking, dilute application, especially in an aqueous medium, is favoured.

Compounds as defined in the first object of the invention may be implemented at a concentration ranging from 1 μg/mL to 200 g/mL, preferably from 5 μg/mL to 150 μg/mL, and even more preferably from 10 μg/mL to 100 μg/mL as compound(s) as defined in the first object of the invention.

Or course, this effective concentration is likely to vary as a function of the chemical nature of the compounds as defined in the first object of the invention, the formulation method, as well as the variety and development stage of the undesirable plants to be treated.

It is also advantageous for the formulation to be suitable for spraying.

When the compounds according to the invention are represented by formula (Ia) of the invention with R³=OH, X=O, R^{4c}=H, and R^{4d}=H (compounds hereinafter referred to as (Ia′)), they can be prepared by condensation reaction of an a, β-unsaturated aldehyde of the formula (II) with a diphenol of the formula (III) according to the step illustrated in the following scheme:

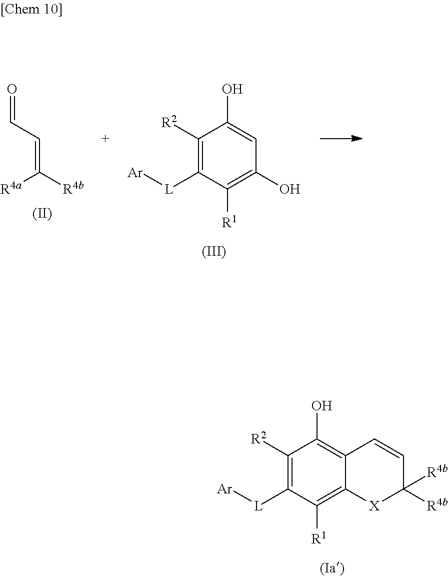

in the presence of an acid catalyst selected from ethylene diamine diacetate (EDDA), Lewis acids such as Yb(OTf)₃, ZnCl₂, and Bronsted acids such as NH₄OAc, TFA, or AcOH; an apolar aprotic solvent or an acid solvent, in a closed reactor (e.g. sealed tube), under reflux, and under an inert atmosphere.

The apolar aprotic solvent may be toluene, xylene, benzene or dichloromethane.

The acid solvent may be acetic acid.

The aldehyde of the formula (II) especially when it is not commercially available, can be obtained according to the three steps illustrated in the following scheme:

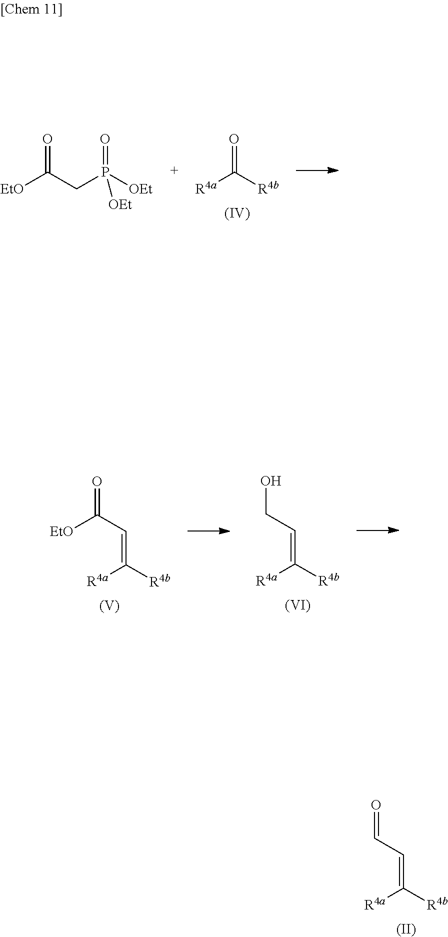

the first step comprising reacting triethyl phosphonoacetate with a ketone of the formula (IV) in the presence of a strong base such as NaH, potassium tert-butylate or sodium methylate, and of an aprotic polar solvent such as tetrahydrofuran, methyltetrahydrofuran or toluene, to form compound (V);
the second step comprising reducing under an inert atmosphere the ester function of compound (V) to the alcohol function in the presence of a reducing agent such as diisobutylaluminium hydride (DIBALH), lithium aluminium hydride or lithium borohydride, to form compound (VI); and
the third step comprising oxidising under an inert atmosphere the alcohol function of compound (VI) to aldehyde function in the presence of an oxidant such as MnO₂, NaOCl in the presence of TEMPO, or DMSO in the presence of oxalyl chloride or another electrophilic agent, to form compound (II).

The second object of the invention is a phytotoxic composition comprising, as herbicidal active substance, at least one compound as defined in the first object of the invention, in combination with one or more formulation additives for improving water solubility and/or penetration into plant tissues, such as, for example, anionic, cationic, amphoteric or nonionic surfactants.

The phytotoxic composition may further comprise one or more other active(s) selected from fertilisers, growth regulators and additional herbicidal agents.

The phrase “additional herbicide” according to the invention refers to a herbicide different from a compound as defined in the first object of the invention.

It may in fact be advantageous to combine a compound as defined in the first object of the invention with an additional herbicide whose efficacy may be complementary to that of the compounds as defined in the first object of the invention.

However, this additional herbicide is preferably a compound selected to have a lesser impact on the environment.

Additional herbicides may be selected from ammonium nonanoate, nonanoic acid (=pelargonic acid), medium chain length (i.e. C₈-C₁₂) fatty acids, and salts thereof, urea derivatives, borax, copper sulphate, carboxylic acids (especially acetic acid) and their salts, nitrogen compounds, calcium salts, and a mixture thereof.

The fertiliser is preferably a nitrogenous fertiliser, which may be selected from urea; ammonium salts; especially ammonium chloride, ammonium nitrate or ammonium sulphate; ammonium and potassium phosphate; leather powder; bone powder, plant powder; and a mixture thereof.

Growth regulators may be selected from maleic hydrazide, chloromequat-chloride (e.g. Cyclocel®), auxin derivatives, growth regulators of natural origin, and a mixture thereof.

Advantageously, growth regulators of natural origin are salicylic acid, salicylic acid salts such as ammonium salicylate, jasmonates, auxins, gibberellins, cytokinins, lunularic acid, abscisic acid, or a mixture thereof.

A composition according to the invention may also contain other more conventional additional additives such as surfactants, antifoaming agents, disintegrants, stabilizers, humectants, thickeners or pH regulators.

The selection of these additives is usually made with regard to the form considered for the composition.

The phytotoxic composition may comprise said compound (I) in the pure state or in the form of a plant extract or plant powder containing it.

The phytotoxic composition according to the invention may be in the form of a solid composition, especially in the form of a powder or granules especially suitable for aqueous dilution. The solid composition can also be dispersed directly on the zone to be weeded and solubilised by wetting.

A phytotoxic composition according to the invention may also be in the form of a liquid composition, especially in concentrated or ready-to-use form, especially as a solution or emulsion. Likewise, the liquid composition in concentrated form can be diluted before use by adding adjuvants if necessary.

The third object of the invention is a method for controlling development and/or treating undesirable plants on the surface of a target zone, comprising bringing the target zone into contact with an effective amount of a compound as defined in the first object of the invention, or of at least one phytotoxic composition as defined in the second object of the invention.

Preferably, the compound as defined in the first object of the invention is supplied to the plant via the culture substrate.

This culture substrate may be the soil but also culture media considered for hydroponic cultures.

Advantageously, the compound is directly applied in contact with the culture substrate on the surface of which the plants to be treated are growing.

Advantageously, the contact is made by spraying at least one compound as defined in the first object of the invention or at least one composition as defined in the second object of the invention.

By virtue of the compound as defined in the first object of the invention, the phytotoxic composition as defined in the second object of the invention, or the method as defined in the third object of the invention, the undesirable plant is killed in less than 96 h, preferably in less than 48 h, and even more preferably in less than 24 h after application.

Further characteristics, alternatives and advantages of the use, the phytotoxic composition, or the method according to the invention will become clearer upon reading the following exemplary embodiments, which are given by way of illustrating and not limiting purposes of the invention.

### EXAMPLES

Toluene, acetonitrile and benzene have been distilled over calcium hydride before use and, if necessary, degassed by bubbling nitrogen gas.

Analytical thin layer chromatography (TLC) has been carried out on aluminium silica gel plates (silica gel 60, F254, Merck) and viewed by exposure to ultraviolet light and/or exposure to a basic potassium permanganate solution or a p-anisaldehyde staining solution followed by heating.

Flash column chromatography has been performed on silica 60 (40-63 pm).

Nuclear magnetic resonance spectra (¹H NMR and ¹³C NMR) have been recorded at 25° C. with a Bruker Avance 400 spectrometer (¹H NMR at 400 MHZ, 13C NMR at 100 MHz) using CDCl₃ as the solvent referenced to residual CHCl₃ (δH=7.26 ppm, δC=77.1 ppm). Chemical shifts are given in ppm and coupling constants (J) in Hertz. Data for ¹H NMR spectra are reported as follows: chemical shift ppm (br s=broad singlet, s=singlet, d=doublet, t=triplet, q=quadruplet, dd=doublet of doublets, td=triplet of doublets, ddd=doublet of doublets of doublets, m=multiplet, coupling constants, integration).

High resolution mass spectra (HRMS) have been obtained on a JEOL JMS-GCmate II spectrometer and are reported in m/z.

Infrared spectra have been recorded on a PerkinElmer FTIR spectrometer using the Attenuated Total Reflectance (ATR) technique. Absorption maxima (vₘₐₓ) are reported in wave numbers (cm-1).

### Example 1: Synthesis of Compound Ia1

### Preparation of Dihydropinosylvine of the Formula (IIIa1)

Dihydropinosylvine has been prepared according to the steps illustrated in the following diagram:

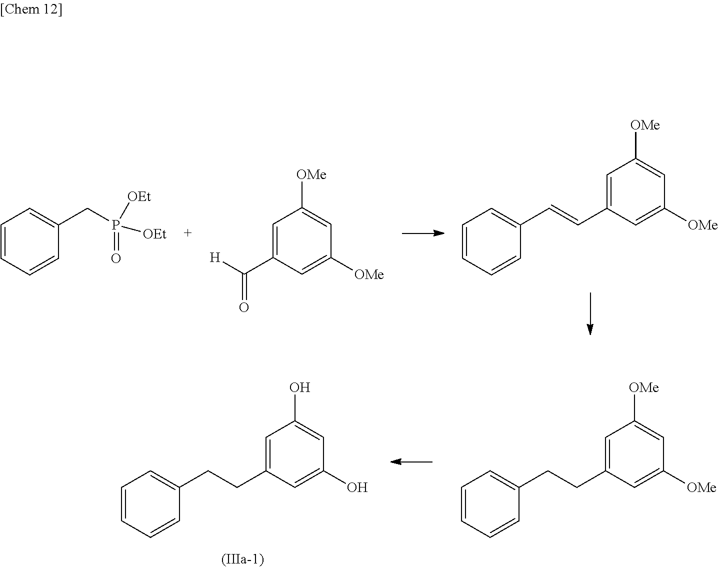

### 1. 1 First Step: Preparation of (E)-3,5-dimethoxystilbene

The first step is a Horner-Wadsworth-Emmons reaction. To a flame-dried 500 mL flask fitted with a magnetic stirring bar, under an inert atmosphere, potassium tert-butylate (t-BuOK) (10.8 g, 96.3 mmol) and anhydrous tetrahydrofuran (THF) (120 mL) have been added. The mixture has been cooled in an ice bath, and then diethyl benzyl phosphonate (20.6 mL, 90.3 mmol) has been added dropwise over 30 minutes, followed by a portionwise addition of 3,5-dimethoxybenzaldehyde (10.0 g, 60.2 mmol). The mixture has been allowed to rise to room temperature and then stirred for 2 h. THF has been removed in vacuo, and then a mixture of water and methanol (H₂O: MeOH) (2:1, about 60 mL) has been added until the product precipitated. Filtration and vacuum drying afforded (E)-3,5-dimethoxystilbene as a white solid (13.5 g, 56.0 mmol, 93% yield).

¹H NMR (400 MHZ, CDCl₃): δ=7.53-7.49 (m, 2H), 7.39-7.33 (m, 2H), 7.29-7.23 (m, 1H), 7. 09 (d, J=16.3 Hz, 1H), 7.04 (d, J=16.3 Hz, 1H), 6.69-6.66 (m, 2H), 6.40 (t, J=2.3 Hz, 1H), 3.83 (s, 6H).

### 1.2. Second Step: Preparation of 1,3-dimethoxy-5-phenethylbenzene

The second step is a catalytic hydrogenation reaction of the double bond implementing ammonium formate. It thus avoids the use of hydrogen gas. (E)-3,5-dimethoxystilbene as prepared in the previous step (14.0 g, 58.2 mmol) and 10% Pd/C (1.40 g, 10% by weight), followed by ethyl acetate (243 mL, 0.245 M) were added to a flame-dried 500 mL flask. Ammonium formate (18.4 g, 291 mmol) has then been added and the mixture left to stir overnight at room temperature. The reaction mixture has then been filtered over celite pad and evaporated in vacuo. The remaining ammonium formate has been precipitated by adding dichloromethane and the mixture has been filtered again and evaporated in vacuo to give the expected 1,3-dimethoxy-5-phenethylbenzene as a light yellow oil (12.7 g, 52.4 mmol, 90% yield).

¹H NMR (400 MHZ, CDCl₃): δ=7.32-7.25 (m, 2H), 7.23-7.17 (m, 3H), 6.36-6.30 (m, 3H), 3.76 (s, 6H), 2.95-2.82 (m, 4H).

### 1.3. Third Step: Preparation of Dihydropinosylvine

The third step is a phenol demethylation in an acidic aqueous medium. To a 250 mL flask fitted with a magnetic stirring bar 1,3-dimethoxy-5-phenethylbenzene as prepared in the previous step (2.03 g, 8.38 mmol) followed by hydrobromic acid (HBr) (24.6 mL, 48 wt % in water) and glacial acetic acid (24.6 mL, HBr: AcOH 1:1 v/v, final concentration 0.15 M) have been added. The reaction mixture has then been heated under reflux for 4 h and allowed to cool to room temperature. The reaction mixture has been diluted with water (50 mL) and extracted with diethyl ether (Et₂O) (3×50 mL). The organic phase has been treated with activated charcoal, filtered and reduced in vacuo to give dihydropinosylvine as a white solid (1.68 g, 7.86 mmol, 94%).

¹H NMR (400 MHZ, CDCl₃): δ=7.33-7.25 (m, 2H), 7.24-7.15 (m, 3H), 6.31-6.18 (m, 3H), 4.71 (br s, 2H), 2.93-2.75 (m, 4H).

### Preparation of 2,2-Dimethyl-7-phenethyl-2H-chromen-5-ol (Compound Ia1)

To a flame-dried sealed tube fitted with a magnetic stirring bar under an inert atmosphere the dihydropinosylvine obtained in the previous step (4.00 g, 18.7 mmoles-1 equiv.) followed by anhydrous toluene (0.1 M) and 3-methyl-2-butenal (prenal) (1.5 equiv.) have been added. Ethylene diamine diacetate (EDDA, 5 mol %) has then been added. The container has been sealed and heated to 115° C. for 1 h. This procedure (addition of EDDA and heating) has been repeated 3 times (addition of 15 mol % EDDA in total), then after returning to room temperature a small amount of silica has been added and the solvent removed under vacuum. The crude mixture has been purified by flash silica column chromatography (dry loading), eluting with hexane/ethyl acetate to give the expected 2,2-dimethyl-7-phenethyl-2H-chromen-5-ol (compound 6) as a viscous brown liquid (4.28 g, 15.3 mmol, 82% yield).

¹H NMR (400 MHZ, CDCl₃): δ=7.31-7.24 (m, 2H), 7.22-7.15 (m, 3H), 6.58 (d, J=10.0, 1H), 6.32-6.29 (m, 1H), 6. 14-6.10 (m, 1H), 5.55 (d, J=10.0, 1H), 4.59 (br s, 1H), 2.92-2.83 (m, 2H), 2.80-2.73 (m, 2H), 1.42 (s, 6H).

### Example 2: Synthesis of Compound Ia1

### Preparation of 2-methyl-7-phenethyl-2H-chromen-5-ol

To a sealed flame-dried tube fitted with a magnetic stirring bar under an inert atmosphere compound (IIIa1) as previously prepared in Example 1 (300 mg, 1.4 mmol, 1 equiv.) followed by anhydrous toluene (0.1 M) and (2E)-but-2-enal (1.5 equiv.) have been added. Ethylene diamine diacetate (EDDA, 5 mol %) has then been added. The container has been sealed and heated to 115° C. for 1 h. This procedure (addition of EDDA and heating) has been repeated 3 times (addition of 15 mol % EDDA in total), then after returning to room temperature a small amount of silica has been added and the solvent removed under vacuum. The crude mixture has been purified by flash silica column chromatography (dry loading), eluting with hexane/EtOAc to give the corresponding chromene (Ia2) as a viscous brown liquid (13 mg, 0.0488 mmol, yield 3%).

¹H NMR (400 MHZ, CDCl₃): δ=7.32-7.13 (m, 5H), 6.65 (d, J=9.8, 1H), 6.33-6.28 (m, 1H), 6. 15-6.08 (m, 1H), 5.58 (d, J=9.8, 1H), 5.02-4.88 (m, 2H), 2.95-2.69 (m, 4H), 1.43 (d, J=6.8, 3H).

### Example 3: Synthesis of Compound Ia3

### Preparation of the Aldehyde of the Formula (IIa3)

The aldehyde of the formula (IIa3) has been prepared according to the steps illustrated in the following scheme:

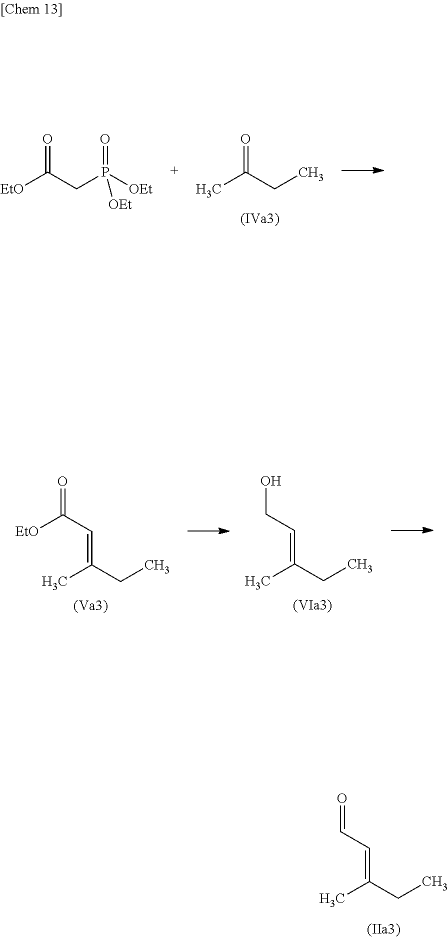

### 3.1 First Step: Preparation of (E/Z) ethyl 3-methylpent-2-enoate

NaH (dispersion in 60% mineral oil, 1.4 equiv.) and anhydrous THF (final concentration: 0.26 M) have been added to a flame-dried round-bottom flask fitted with a magnetic stirring bar under an argon atmosphere. The resulting suspension has been cooled to 0° C., and then triethyl phosphonoacetate (1.5 equiv.) has been added dropwise with a syringe over 30 minutes, followed by butanone of the formula (IVa3) (1.25 mL, 13.9 mmol, 1 equiv.). The mixture has been allowed to warm to room temperature and stirred overnight, then the reaction has been stopped with a NH₄Cl saturated aqueous solution. The aqueous phase has been extracted three times with Et₂OL and the combined organic phases have been dried over magnesium sulphate (MgSO₄), evaporated in vacuo and purified by column chromatography, using CH₂Cl₂ as the eluent, to result in compound (Va3) (E/Z) ethyl 3-methylpent-2-enoate as a viscous yellow liquid (E/Z=78:22, 1.94 g, 13.6 mmol, 98% yield).

E isomer: ¹H NMR (400 MHZ, CDCl₃): δ=5. 67-5.65 (m, 1H), 4.15 (q, J=7.2 Hz, 2H), 2.21-2.12 (m, 5H, H-4), 1.28 (t, J=7.2 Hz, 3H), 1.07 (t, J=7.5 Hz, 3H).

### 3.2 Second Step: Preparation of (E/Z)-3-Methylpent-2-en-1-ol

The compound (Va3) obtained in the previous step (3.88 g, 27.3 mmol, 1 equiv.), followed by dry CH₂Cl₂ (final concentration: 1.12 M) have been added to a flame-dried round-bottom flask fitted with a magnetic stirring bar under an inert atmosphere. The solution has been cooled to 0° C., then DIBALH (1M in CH₂Cl₂, 2.1 equiv.) has been added by syringe and the mixture has been stirred for 2 h. The reaction has been stopped by adding MeOH (2.5 equiv.) at 0° C. and allowed to rise to room temperature. A saturated NaCl solution has then been added, followed by Et₂O, and the mixture filtered through celite. The phases have been separated and the organic phases dried over MgSO₄ and concentrated in vacuo. The crude mixture has been purified by flash column chromatography using a mixture Et₂O:CH₂Cl₂ (5% Et₂O:CH₂Cl₂) as eluent to afford compound (VIa3) (E/Z)-3-Methylpent-2-en-1-ol as a colourless liquid (E/Z=78:22, 1.39 g, 13.9 mmol, 51% yield).

E isomer: ¹H NMR (400 MHZ, CDCl₃): D=5. 44-5.35 (m, 1H), 4.20-4.10 (m, 2H), 2.14-2.00 (m, 2H), 1.76-1.66 (m, 3H), 1.05-0.98 (m, 3H).

### 3.3 Third Step: Preparation of (E/Z)-3-Methylpent-2-enal

To a flame-dried round-bottom flask fitted with a magnetic stirring bar under an inert atmosphere, MnO₂ (5 equiv.) and anhydrous CH₂Cl₂ (0.49 M), followed by the compound (VIa3) obtained in the previous step (930 mg, 9.29 mmol, 1 equiv.) have been added. A condenser has been connected and the mixture has been heated under reflux overnight. The mixture has then been allowed to cool to room temperature and filtered through a celite pad. The solvent has been removed in vacuo and the crude mixture purified by flash column chromatography, with a (1:1) CH₂Cl₂/pentane mixture as eluent, to result in compound (IIa3) (E/Z)-3-Methylpent-2-enal as a colourless liquid (E/Z=78:22, 400 mg, 13.9 mmol, 44% yield).

E isomer: ¹H NMR (400 MHZ, CDCl₃): 0=9.97 (d, J=8.2, 1H, H-1), 5.86-5.81 (m, 1H, H-2), 2.60 (q, J=7.5, 2H, H-3), 1.98 (d, J=1.3, 3H, H-4), 1.17 (t, J=7.6, 3H, H-5).

### Preparation of 2-ethyl-2-methyl-7-phenethyl-2H-chromen-5-ol (Compound Ia3)

To a sealed flame-dried tube fitted with a magnetic stirring bar under an inert atmosphere compound (IIIa1) as previously prepared in Example 1 (50 mg, 0.233 mmol, 1 equiv.) followed by anhydrous toluene (0.1 M) and aldehyde (IIa3) as previously prepared in Example 3 (1.5 equiv.) have been added. Ethylene diamine diacetate (EDDA, 5 mol %) has then been added. The container has been sealed and heated to 115° C. for 1 h. This procedure (EDDA addition and heating) has been repeated 3 times (addition of 15 mol % EDDA in total), then after returning to room temperature a small amount of silica has been added and the solvent removed under vacuum. The crude mixture has been purified by flash silica column chromatography (dry loading), eluting with hexane/EtOAc (95:5, Rf=0.28) to give the corresponding chromene (Ia3) as a yellow viscous liquid (27 mg, 0.0017 mmol, 39%).

¹H NMR (400 MHZ, CDCl₃): δ=7.30-7.24 (m, 2H), 7.22-7.14 (m, 3H), 6.26 (d, J=10.1, 1H), 6.30-6.27 (m, 1H), 6.11-6.08 (m, 1H), 5. 49 (d, J=10.1, 1H), 4.85-4.68 (br s, 1H), 2.90-2.81 (m, 2H), 2.80-2.71 (m, 2H), 1.79-1.62 (m, 2H), 1.36 (s, 3H), 0.95 (t, J=7.5, 3H).

¹³C NMR (101 MHz, CDCl₃): δ=154.2, 151.1, 143.5, 141.7, 128.4, 128.3, 127.4, 125.9, 116.9, 109.1, 107.7, 107.3, 78.6, 37.9, 37.4, 33.7, 25.8, 8.2.

IR (ATR): 3404, 2972, 2929, 2869, 1623, 1576, 1496, 1434, 1136, 1062, 829.

HRMS (ESI+): Calc. for C₂₀H₂₃O₂⁺ [MH⁺]: 295.1693; Obtained: 295.1686.

### Example 4: Synthesis of Compound IC₁

To a flame-dried sealed tube fitted with a magnetic stirring bar under an inert atmosphere, compound (Ia1) (100 mg, 0.36 mmol) and 10% Pd/C (10 mg, 10% by mass), followed by ethyl acetate (1.52 mL, 0.245 M) have been added. Ammonium formate (115 mg, 1.82 mmol) has then been added and the mixture left to stir overnight at room temperature. Next, 10 wt % Pd/C (10 mg) and ammonium formate (68.09 mg, 1.08 mmol) have been added again. The reaction mixture has been left to stir for 3 h and then filtered over celite pad and evaporated in vacuo. The remaining ammonium formate has been precipitated by addition of dichloromethane and the mixture has been filtered again then evaporated in vacuo to give the expected compound (IC₁) as a pale yellow liquid (97.2 mg, 0.34 mmol, 97% yield).

¹H NMR (400 MHZ, CDCl₃): δ=7.32-7.24 (m, 2H), 7.22-7.14 (m, 2H), 6.33 (d, 1H), 6.19 (d, 1H), 4.63-4.59 (br s, 1H), 2.92-2.70 (m, 2H), 2.63 (t, 1H), 1.81 (t, 1H), 1.33 (s, 6H).

### Example 5: Use of Compounds (Iai), (Ia2), (Ia3) and (IC₁) as Herbicidal Agents

Biological tests have been carried out under axenic conditions on Arabidopsis thaliana ecotype Col-0 seedlings cultured in hydroponics at the cotyledon stage. Sterilised seeds have been sown in microplates (10 seeds per well containing 200 μL of distilled water) and cultured for 10-13 days at 22° C. under a 16 h/8 h (day/night) photoperiod lighting. The treatment has been carried out by replacing the culture medium with an equivalent volume of water containing the molecule to be tested dissolved in DMSO. The maximum DMSO concentration in the treated wells was 1% by volume. A control has therefore been set up with the presence of DMSO at this concentration. The phytotoxicity of the treatment has been evaluated after 48 h of culture, by visual analysis of the chlorosis induced.

By way of comparison, tests have also been carried out under the same conditions as for compounds (Ia1), (Ia2), (Ia3) and (IC₁), but with two comparative compounds not forming part of the invention:
a compound (2) including a diphenol ring in place of the chromene ring, and
a compound (3) including a chromene ring but not including an -L-Ar group.
   All compounds have been tested at a concentration of 125 pM.

The results are given in Table 2 hereinafter.

Herbicidal activity is indicated by A for Active in the event that the plant is killed, i.e. when both cotyledons have lost all their green coloration, 48 h after application of the product.

The absence of herbicidal activity is indicated by “N” for Not active, in the case where no biological activity is observed

TABLE 2

| | | Activity after |
|---|---|---|
| Name | Structural formula | 48h |
| Compound Ia1 | 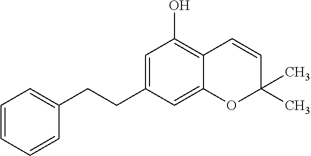 [SMILES: CC1(C)C=Cc2c(O)cc(CCc3ccccc3)cc2O1] | A |
| | [Chem 14] | |
| Compound Ia2 | 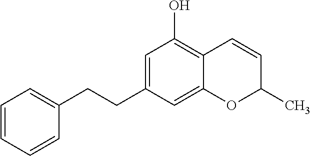 [SMILES: CC1C=Cc2c(O)cc(CCc3ccccc3)cc2O1] | A |
| | [Chem 15] | |
| Compound Ia3 | 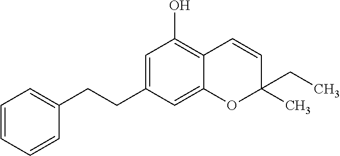 [SMILES: CCC1(C)C=Cc2c(O)cc(CCc3ccccc3)cc2O1] | A |
| | [Chem 16] | |
| Compound Ic1 | 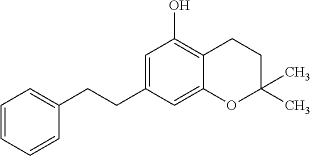 [SMILES: CC1(C)CCc2c(O)cc(CCc3ccccc3)cc2O1] | A |
| | [Chem 17] | |
| Compound 2 not in accordance with the invention | 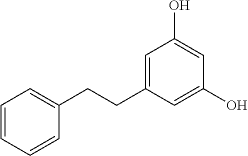 [SMILES: Oc1cc(O)cc(CCc2ccccc2)c1] | N |
| | [Chem 18] | |
| Compound 3 not in accordance with the invention | 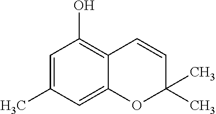 | N |
| | [Chem 19] | |

As is apparent from the above table, compounds 2 and 3 not in accordance with the invention show no herbicidal activity at the concentration tested.

These tests highlight that:
the presence of a heterobicyclic ring is essential (comparison between the compound of the formula Ia1 in accordance with the invention and the compound (2) not in accordance with the invention,
substitution of this heterobicyclic ring with a group of the -L-Ar type is also essential (comparison between the compound of the formula Ia1 in accordance with the invention and the compound (3) not in accordance with the invention.

1-14. (canceled)

15. A herbicidal agent comprising at least one compound selected from a compound having the formula (I), an isomer thereof, and one of their organic and inorganic salts,
said formula (I) having the following structure: 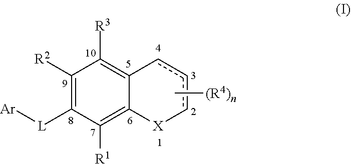
wherein:
R¹, R² and R³ represent, independently of each other, a hydrogen atom, a halogen atom, a C₁-C₅ alkyl or cycloalkyl radical, or a group selected from —OH, —COOH, —COOR⁵, —OR⁵ and —SO₂R⁵, with R⁵ being a C₁-C₅ alkyl or cycloalkyl radical, it being possible for said C₁-C₅ alkyl or cycloalkyl radical to be substituted with one or more substituents selected from a halogen atom and a hydroxyl group,
X is part of a six-membered heterocycle and represents an oxygen atom, a sulphur atom, a divalent SO group, a divalent SO₂ group and a divalent NR⁶ group, with R⁶ being a hydrogen atom, a C₁-C₅ alkyl or cycloalkyl radical, or a C₂-C₈ aryl or heteroaryl radical,
the symbol [symbol] represents a single bond or a double bond in the 2,3- or 3,4-position of the six-membered heterocycle bearing the heteroatom or the divalent group X, so that said six-membered heterocycle comprises either two single bonds in the 2,3- and 3,4-positions, or a single bond in the 2,3-position and a double bond in the 3,4-position, or a double bond in the 2,3-position and a single bond in the 3,4-position,
L represents a bonding arm selected from linear and branched alkylene chains having at least one carbon atom, it being possible for said linear or branched alkylene chains to be interrupted and/or terminated by one or more heteroatoms selected from an oxygen, sulphur or substituted nitrogen atom,
Ar represents an aromatic group selected from phenyl, naphthyl, furyl, thiophenyl, pyrrolyl, pyridinyl, indolyl, isoindolyl, benzofuryl, benzothiophenyl, quinolyl and isoquinolyl, imidazolyl, oxazolyl, thiazolyl, pyrimidyl, pyridazyl, pyrazyl, pyrrazolyl and triazolyl groups, it being possible for said aromatic group to be substituted with one or more substituents selected from a halogen atom, a C₁ to C₅ alkyl or cycloalkyl radical, an —OH group, a —COOH group, a —COOR⁷ group, an —OR⁷ group, and an —SO₂R⁷ group, with R⁷ being a C₁ to C₅ alkyl or cycloalkyl radical, it being possible for said C₁ to C₅ alkyl or cycloalkyl radical to be substituted with one or more substituents selected from a halogen atom and a hydroxyl group,
n is an integer ranging from 4 to 6 and represents the number of identical or different substituents R⁴ present on the six-membered heterocycle, and
R⁴ represents a hydrogen atom, a halogen atom, a C₁ to C₅ alkyl or cycloalkyl radical, or a group selected from —OH, —COOH, —COOR⁸, —OR⁸ and —SO₂R⁸, with R⁸ being a C₁ to C₅ alkyl or cycloalkyl radical, it being possible for said C₁ to C₅ alkyl or cycloalkyl radical to be substituted with one or more substituents selected from a halogen atom and a hydroxyl group.

16. The herbicidal agent according to claim 15, wherein X represents an oxygen atom.

17. The herbicidal agent according to claim 15, wherein the at least one of the groups R¹, R² and R³ represents an —OH group.

18. The herbicidal agent according to claim 15, wherein the group R³ represents an —OH group, and the other two groups R¹ and R² represent, independently of each other, a hydrogen atom, a —COOH group or a —COOR⁵ group, with R⁵ being a C₁ to C₅ alkyl radical.

19. The herbicidal agent according to claim 15, wherein L represents a linear alkylene chain having from 1 to 6 carbon atoms.

20. The herbicidal agent according to claim 15, wherein Ar represents a phenyl group, wherein said phenyl group can be substituted with one or more substituents as defined above.

21. The herbicidal agent according to claim 15, wherein the heterocycle comprises a double bond, the compound of the formula (I) then having the following formula (Ia) or (Ib): 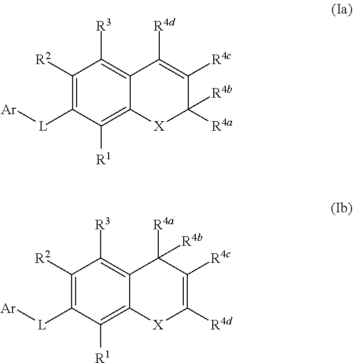
wherein:
Ar, L, R¹, R², R³ and X are as defined above, and
R^{4a}, R^{4b}, R^{4c} and R^{4d}, which may be identical or different, represent a hydrogen atom or a C₁-C₅ alkyl or cycloalkyl radical, it being possible for said C₁-C₅ alkyl or cycloalkyl radical to be substituted with one or more halogen atoms.

22. The herbicidal agent according to claim 21, wherein R^{4a} represents a C₁-C₃ alkyl radical optionally substituted with one or more halogen atoms, R^{4b} represents a hydrogen atom or a C₁-C₃ alkyl radical optionally substituted with one or more halogen atoms, and R^{4c} and R^{4d} represent a hydrogen atom.

23. The herbicidal agent according to claim 15, wherein the heterocycle does not comprise a double bond, the compound of the formula (I) then having the following formula (Ic): 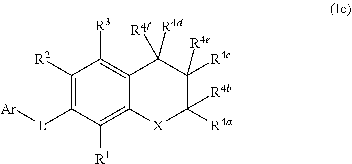
wherein:
Ar, L, R¹, R², R³ and X are as defined above, and
R^{4a}, R^{4b}, R^{4c}, R^{4d}, R^{4e}, and R^{4f}, which may be identical or different, represent a hydrogen atom or a C₁-C₅ alkyl or cycloalkyl radical, it being possible for said C₁-C₅ alkyl or cycloalkyl radical to be substituted with one or more halogen atoms.

24. The herbicidal agent according to claim 23, wherein R^{4a} and R^{4b} represent a methyl radical, and R^{4c}, R^{4d}, R^{4e}, and R^{4f} represent a hydrogen atom.

25. The herbicidal agent according to claim 15, wherein the compound of the formula (I) is selected from the following compounds:
TABLE 3

| Name | Structural formula |
|---|---|
| Compound Ia1 | 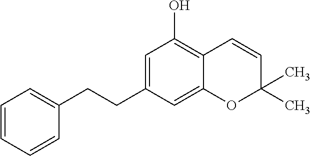 [SMILES: CC1(C)C=Cc2c(O)cc(CCc3ccccc3)cc2O1] |
| | [Chem 23] |
| Compound Ia2 | 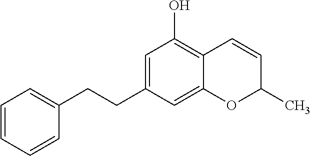 [SMILES: CC1C=Cc2c(O)cc(CCc3ccccc3)cc2O1] |
| | [Chem 24] |
| Compound Ia3 | 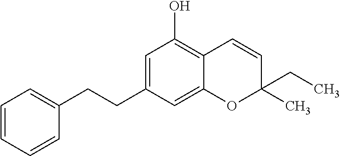 [SMILES: CCC1(C)C=Cc2c(O)cc(CCc3ccccc3)cc2O1] |
| | [Chem 25] |
| Compound Ic1 | 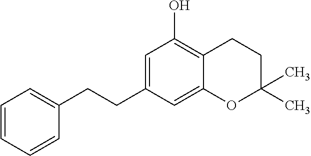 [SMILES: CC1(C)CCc2c(O)cc(CCc3ccccc3)cc2O1] |
| | [Chem 26] |

26. A phytotoxic composition, comprising as an herbicidal active substance, at least one herbicidal agent according to claim 15, in combination with one or more formulation additives for improving water solubility and/or penetration into plant tissues.

27. The phytotoxic composition according to claim 26, further comprising one or more other active ingredients selected from fertilisers, growth regulators and additional herbicidal agents.

28. A method for controlling development and/or treating undesirable plants on the surface of a target zone comprising contacting the target zone with an effective amount of:
at least herbicidal agent as defined in claim 15,
at least one phytotoxic composition comprising as an herbicidal active substance, said at least one herbicidal agent, in combination with one or more formulation additives for improving water solubility and/or penetration into plant tissues; or
at least one phytotoxic composition comprising as an herbicidal active substance, said at least one herbicidal agent, in combination with one or more formulation additives for improving water solubility and/or penetration into plant tissues and with one or more other active ingredients selected from fertilisers, growth regulators and additional herbicidal agents.
